(19) United States
(12) Patent Application Publication
(10) Pub. No.: US 2014/0029960 A1
(43) Pub. Date: Jan. 30, 2014

(54) Magnetic Interlock for a Replaceable Unit of an Image Forming Device

(71) Applicants: Adam Jude Ahne, Lexington, KY (US); William George Goff, III, Lexington, KY (US); Matthew Lee Rogers, Lexington, KY (US)

(72) Inventors: Adam Jude Ahne, Lexington, KY (US); William George Goff, III, Lexington, KY (US); Matthew Lee Rogers, Lexington, KY (US)

(21) Appl. No.: 13/557,519

(22) Filed: Jul. 25, 2012

(51) Int. Cl. G03G 15/08

(52) U.S. Cl. 399/13; 399/262

(57) ABSTRACT

A replaceable unit for an electrophotographic image forming device according to one example embodiment includes a housing having a reservoir for storing a quantity of toner. An insertion alignment guide is positioned on the housing. The insertion alignment guide has a magnet for detection by a magnetic sensor in the image forming device.

### CROSS REFERENCES TO RELATED APPLICATIONS

None.

### BACKGROUND

1. Field of the Disclosure

The present invention relates generally to electrophotographic image forming devices and more particularly to a magnetic interlock for a replaceable unit of an electrophotographic image forming device.

2. Description of the Related Art

During the electrophotographic printing process, an electrically charged rotating photoconductive drum is selectively exposed to a laser beam. The areas of the photoconductive drum exposed to the laser beam are discharged creating an electrostatic latent image of a page to be printed on the photoconductive drum. Toner particles are then electrostatically picked up by the latent image on the photoconductive drum creating a toned image on the drum. The toned image is transferred to the print media (e.g., paper) either directly by the photoconductive drum or indirectly by an intermediate transfer member. The toner is then fused to the media using heat and pressure to complete the print.

The image forming device's toner supply is stored in one or more replaceable units. For example, a toner cartridge may be used that houses the device's toner supply as well as the photoconductive drum and other related components. Alternatively, components having a longer life may be separated from those having a shorter life in separate replaceable units. In this configuration, relatively longer life components such as a developer roll, a toner adder roll, a doctor blade and a photoconductive drum may be positioned in one replaceable unit (an “imaging unit”). The image forming device's toner supply, which is consumed relatively quickly in comparison with the components housed in the imaging unit, may be provided in a reservoir in a separate replaceable unit in the form of a toner cartridge that mates with the imaging unit.

In many devices, the replaceable unit(s) physically block a user from accessing the light path of the laser beam inside the device. However, in some devices, it may be possible for the user to access the laser beam when the replaceable unit(s) are removed such as by using a mirror or the like. If the laser beam is redirected outside of the image forming device, it could potentially damage the user's eyes. As a result, some image forming devices use a metal strip on one or more of the replaceable units to disable the laser when one of the replaceable units is removed from the device. When the replaceable unit(s) are inserted into the image forming device, the strip shorts between electrical contacts in the device and provides a current path to energize a laser power relay. When one of the replaceable units is removed from the device, the strip separates from the electrical contacts opening the current path of the laser power relay thereby disabling the laser. However, this solution requires the replaceable unit(s) to be inserted to a precise location inside the image forming device in order to establish reliable contact between the strip and the electrical contacts in the image forming device. Further, in some instances, it may be possible for toner dust inside the device to disrupt the contact between the strip and the electrical contacts. Accordingly, an interlock that reliably prevents the laser from operating unless the replaceable unit(s) are installed is desired.

### SUMMARY

A replaceable unit for an electrophotographic image forming device according to a first example embodiment includes a housing having a reservoir for storing a quantity of toner. An insertion alignment guide is positioned on the housing. The insertion alignment guide has a magnet for detection by a magnetic sensor in the image forming device.

A replaceable unit for an electrophotographic image forming device according to a second example embodiment includes a housing having a reservoir for storing a quantity of toner. A guide is positioned on the housing for aligning the replaceable unit when the replaceable unit is inserted in the image forming device. A magnet on the guide is detectable by a magnetic sensor in the image forming device when the replaceable unit is inserted in the image forming device.

A replaceable unit for use in an electrophotographic image forming device according to a third example embodiment includes a housing having a reservoir for storing a quantity of toner. An insertion alignment guide is positioned on the housing. A magnet on the housing produces a magnetic field of at least about 5 Gauss at an outer surface of the insertion alignment guide.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a block diagram of an imaging system according to one example embodiment.

FIG. 2 is a perspective view of a toner cartridge and an imaging unit according to one example embodiment.

FIG. 3 is a perspective view of the toner cartridge shown in FIG. 2.

FIG. 4 is an exploded view of the toner cartridge shown in FIGS. 2 and 3.

FIG. 5 is a cutaway view of a developer unit of the imaging unit shown in FIG. 2.

FIG. 6 is a side view showing the toner cartridge of FIG. 2 as it is inserted into an image forming device.

FIG. 7 is a schematic diagram of a magnetic sensor configured to detect a magnet on an insertion alignment guide of the toner cartridge when the toner cartridge is inserted into the image forming device.

FIG. 8 is a perspective view of an inner surface of an end cap of the toner cartridge shown in FIGS. 2-4 showing a magnet positioned thereon.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

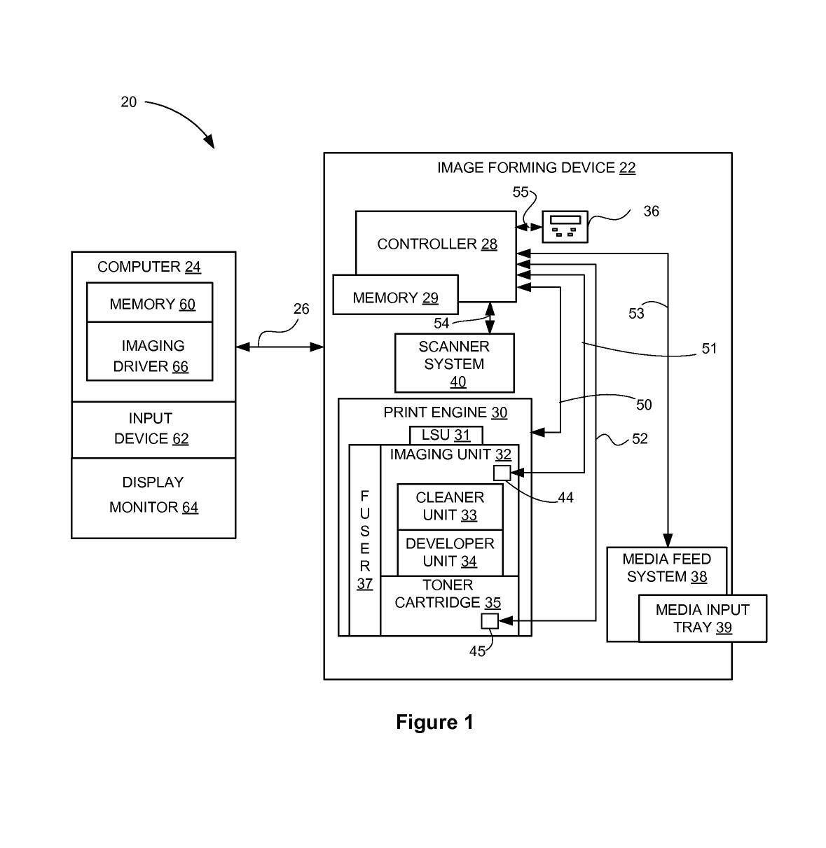

Referring now to the drawings and particularly to FIG. 1, there is shown a block diagram depiction of an imaging system 20 according to one example embodiment. Imaging system 20 includes an image forming device 22 and a computer 24. Image forming device 22 communicates with computer 24 via a communications link 26. As used herein, the term “communications link” generally refers to any structure that facilitates electronic communication between multiple components and may operate using wired or wireless technology and may include communications over the Internet.

In the example embodiment shown in FIG. 1, image forming device 22 is a multifunction machine (sometimes referred to as an all-in-one (AIO) device) that includes a controller 28, a print engine 30, a laser scan unit (LSU) 31, an imaging unit 32, a toner cartridge 35, a user interface 36, a media feed system 38, a media input tray 39 and a scanner system 40. Image forming device 22 may communicate with computer 24 via a standard communication protocol, such as for example, universal serial bus (USB), Ethernet or IEEE 802.xx. Image forming device 22 may be, for example, an electrophotographic printer/copier including an integrated scanner system 40 or a standalone electrophotographic printer.

Controller 28 includes a processor unit and associated memory 29 and may be formed as one or more Application Specific Integrated Circuits (ASICs). Memory 29 may be any volatile or non-volatile memory or combination thereof such as, for example, random access memory (RAM), read only memory (ROM), flash memory and/or non-volatile RAM (NVRAM). Alternatively, memory 29 may be in the form of a separate electronic memory (e.g., RAM, ROM, and/or NVRAM), a hard drive, a CD or DVD drive, or any memory device convenient for use with controller 28. Controller 28 may be, for example, a combined printer and scanner controller.

In the example embodiment illustrated, controller 28 communicates with print engine 30 via a communications link 50. Controller 28 communicates with imaging unit 32 and processing circuitry 44 thereon via a communications link 51. Controller 28 communicates with toner cartridge 35 and processing circuitry 45 thereon via a communications link 52. Controller 28 communicates with media feed system 38 via a communications link 53. Controller 28 communicates with scanner system 40 via a communications link 54. User interface 36 is communicatively coupled to controller 28 via a communications link 55. Processing circuitry 44, 45 may provide authentication functions, safety and operational interlocks, operating parameters and usage information related to imaging unit 32 and toner cartridge 35, respectively. Controller 28 processes print and scan data and operates print engine 30 during printing and scanner system 40 during scanning.

Computer 24, which is optional, may be, for example, a personal computer, including memory 60, such as RAM, ROM, and/or NVRAM, an input device 62, such as a keyboard and/or a mouse, and a display monitor 64. Computer 24 also includes a processor, input/output (I/O) interfaces, and may include at least one mass data storage device, such as a hard drive, a CD-ROM and/or a DVD unit (not shown). Computer 24 may also be a device capable of communicating with image forming device 22 other than a personal computer such as, for example, a tablet computer, a smartphone, or other electronic device.

In the example embodiment illustrated, computer 24 includes in its memory a software program including program instructions that function as an imaging driver 66, e.g., printer/scanner driver software, for image forming device 22. Imaging driver 66 is in communication with controller 28 of image forming device 22 via communications link 26. Imaging driver 66 facilitates communication between image forming device 22 and computer 24. One aspect of imaging driver 66 may be, for example, to provide formatted print data to image forming device 22, and more particularly to print engine 30, to print an image. Another aspect of imaging driver 66 may be, for example, to facilitate the collection of scanned data from scanner system 40.

In some circumstances, it may be desirable to operate image forming device 22 in a standalone mode. In the standalone mode, image forming device 22 is capable of functioning without computer 24. Accordingly, all or a portion of imaging driver 66, or a similar driver, may be located in controller 28 of image forming device 22 so as to accommodate printing and/or scanning functionality when operating in the standalone mode.

Print engine 30 includes laser scan unit (LSU) 31, toner cartridge 35, imaging unit 32, and a fuser 37, all mounted within image forming device 22. Imaging unit 32 is removably mounted in image forming device 22 and includes a developer unit 34 that houses a toner reservoir (or toner sump) and a toner delivery system. The toner delivery system includes a toner adder roll that provides toner from the toner sump to a developer roll. A doctor blade provides a metered uniform layer of toner on the surface of the developer roll. Imaging unit 32 also includes a cleaner unit 33 that houses a photoconductive drum and a waste toner removal system. Toner cartridge 35 is also removably mounted in imaging unit 32 in a mating relationship with developer unit 34 of imaging unit 32. An exit port on toner cartridge 35 communicates with an inlet port on developer unit 34 allowing toner to be periodically transferred from a reservoir in toner cartridge 35 to resupply the toner sump in developer unit 34.

The electrophotographic printing process is well known in the art and, therefore, is described briefly herein. During a printing operation, laser scan unit 31 creates an electrostatic latent image on the photoconductive drum in cleaner unit 33. Toner is transferred from the toner sump in developer unit 34 to the latent image on the photoconductive drum by the developer roll to create a toned image. The toned image is then transferred to a media sheet received in imaging unit 32 from media input tray 39 for printing. Toner remnants are removed from the photoconductive drum by the waste toner removal system. The toner image is bonded to the media sheet in fuser 37 and then sent to an output location or to one or more finishing options such as a duplexer, a stapler or a hole-punch.

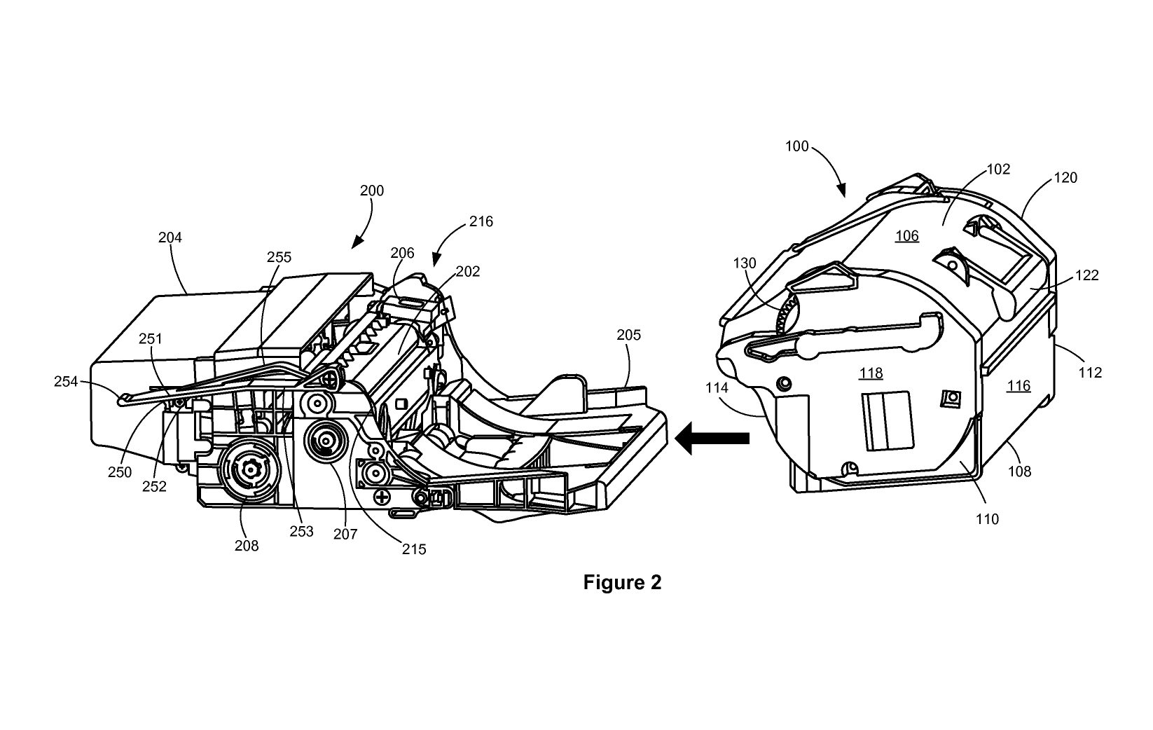

Referring now to FIG. 2, a toner cartridge 100 and an imaging unit 200 are shown according to one example embodiment. Imaging unit 200 includes a developer unit 202 and a cleaner unit 204 mounted on a common frame 205. Imaging unit 200 and toner cartridge 100 are each removably installed in image forming device 22 along a common entry path. Imaging unit 200 is first slidably inserted into image forming device 22. Toner cartridge 100 is then inserted into image forming device 22 and onto frame 205 in a mating relationship with developer unit 202 of imaging unit 200 as indicated by the arrow shown in FIG. 2. This arrangement allows toner cartridge 100 to be removed and reinserted easily when replacing an empty toner cartridge without having to remove imaging unit 200. Imaging unit 200 may also be readily removed as desired in order to maintain, repair or replace the components associated with developer unit 202, cleaning unit 204 or frame 205 or to clear a media jam.

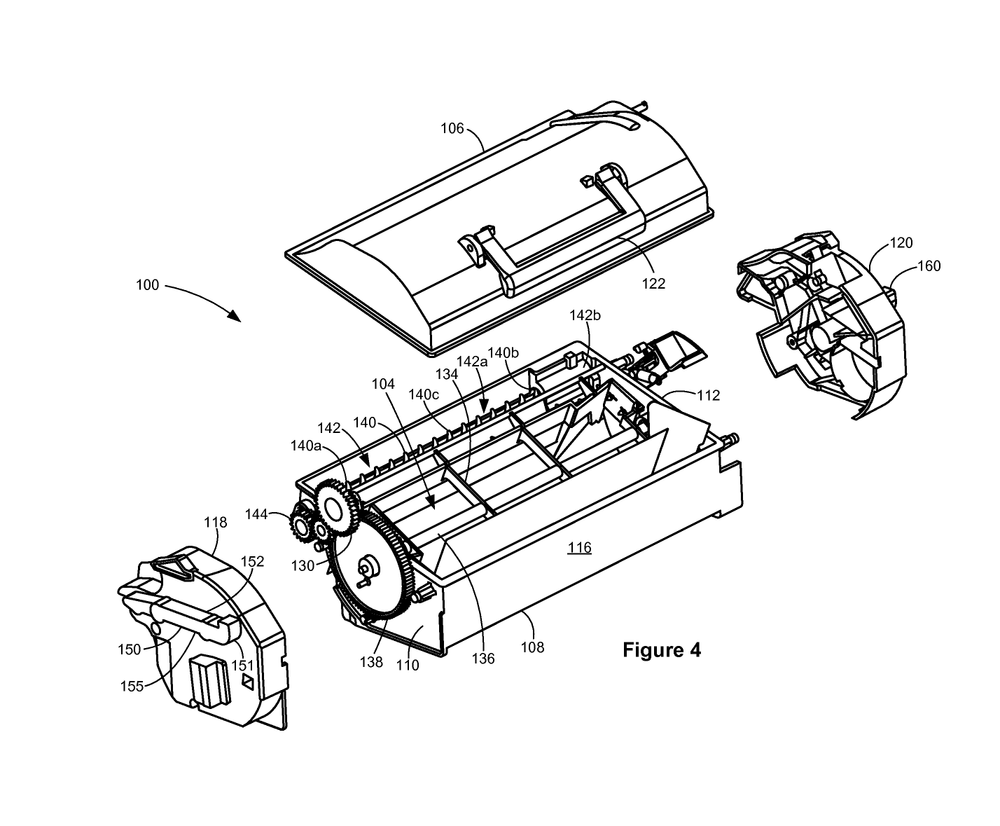

With reference to FIGS. 2-4, toner cartridge 100 includes a housing 102 having an enclosed reservoir 104 (FIG. 4) for holding a quantity of toner therein. Housing 102 may be viewed as having a top or lid 106 mounted on a base 108. Base 108 includes first and second side walls 110, 112 connected to adjoining front and rear walls 114, 116. In one embodiment, top 106 is ultrasonically welded to base 108 thereby forming enclosed reservoir 104. Housing 102 also includes first and second end caps 118, 120 mounted to side walls 110, 112, respectively. First and second end caps 118, 120 may be snap fitted into place or attached by screws or other fasteners. A handle 122 may be provided on top 106 or base 108 of toner cartridge 100 to assist with insertion and removal of toner cartridge 100 from imaging unit 200 and image forming device 22.

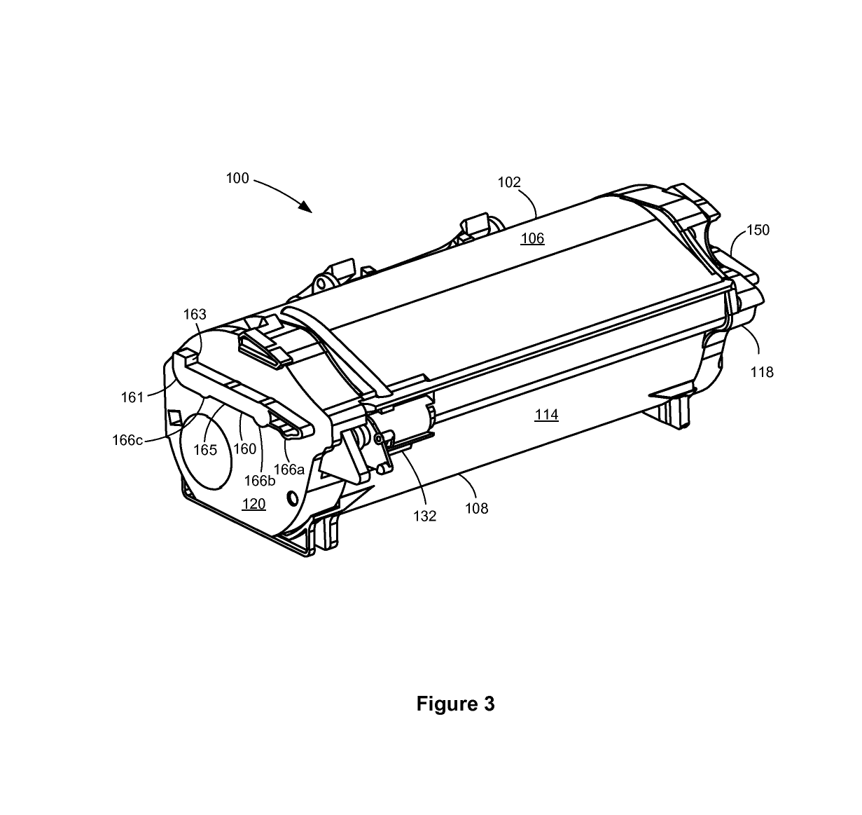

With reference to FIG. 4, various drive gears are housed within a space formed between end cap 118 and side wall 110. A main interface gear 130 engages with a first drive system in image forming device 22 that provides torque to main interface gear 130. Various linkages may be housed within a space formed between end cap 120 and side wall 112 for actuating a shutter that regulates the flow of toner out of an exit port 132 provided in front wall 114 (FIG. 3). One or more paddles 134 are rotatably mounted within toner reservoir 104 with first and second ends of a drive shaft 136 of paddle(s) 134 extending through aligned openings in side walls 110, 112, respectively. A drive gear 138 is provided on the first end of drive shaft 136 that engages with main interface gear 130 either directly or via one or more intermediate gears. Bushings may be provided on each end of drive shaft 136 where it passes through side walls 110, 112.

An auger 140 having first and second ends 140a, 140b, and a spiral screw flight 140c is positioned in a channel 142 extending along the width of front wall 114 between side walls 110, 112. Channel 142 may be integrally molded as part of front wall 114 or formed as a separate component that is attached to front wall 114. Channel 142 is generally horizontal in orientation along with toner cartridge 100 when toner cartridge 100 is installed in image forming device 22. First end 140a of auger 140 extends through side wall 110 and a drive gear 144 is provided on first end 140a that engages with main interface gear 130 either directly or via one or more intermediate gears. Channel 142 includes an open portion 142a and an enclosed portion 142b. Open portion 142a is open to toner reservoir 104 and extends from side wall 110 toward second end 140b of auger 140. Enclosed portion 142b of channel 142 extends from side wall 112 and encloses second end 140b of auger 140 and the shutter that regulates whether toner is permitted to exit toner cartridge 100 through exit port 132. As paddle(s) 134 rotate, they deliver toner from toner reservoir 104 into open portion 142a of channel 142. Auger 140 is rotated via drive gear 144 to deliver toner received in channel 142 to the shutter housed in enclosed portion 142b of channel 142. In this embodiment, exit port 132 is disposed at the bottom of channel 142 so that gravity will assist in exiting toner through exit port 132 (FIG. 3).

With reference back to FIG. 2, developer unit 202 includes an inlet port 206 that aligns with exit port 132 of toner cartridge 100 when toner cartridge 100 is installed along frame 205 and mated with developer unit 202. Imaging unit 200 includes a pair of drive couplers 207, 208 exposed through a side portion of frame 205 that receive torque at their axial ends from a second and a third drive system, respectively, in image forming device 22. Drive coupler 207 drives various rotatable components in developer unit 202 as discussed below. Drive coupler 208 drives the photoconductive drum in cleaner unit 204.

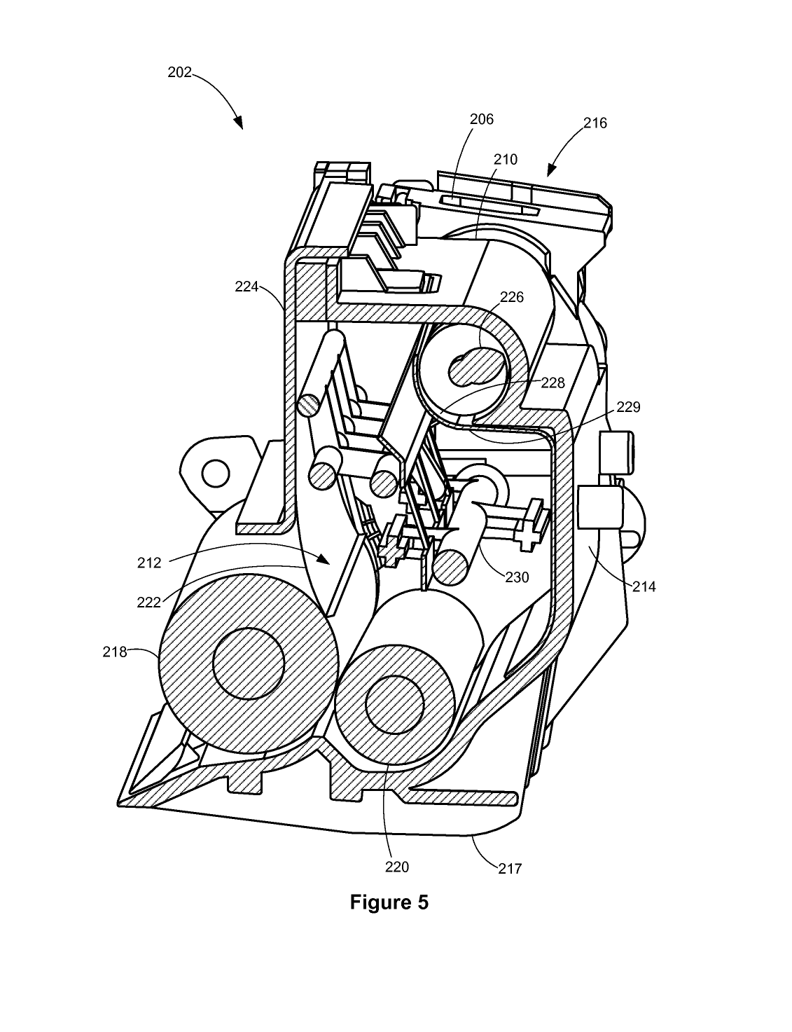

With reference to FIGS. 2 and 5, developer unit 202 includes a housing 210 enclosing a toner reservoir 212 sized to hold a quantity of toner. Toner reservoir 212 is formed by a rear wall 214, a first side wall 215 (FIG. 2), a second side wall 216 and a bottom 217. FIG. 5 shows a cutaway view of developer unit 202 through a side portion of housing 210 to more clearly illustrate the internal components of developer unit 202. Cleaner unit 204, which is positioned in front of developer unit 202 (i.e., to the left in FIG. 5), and frame 205 are not shown. A developer roll 218 and a toner adder roll 220 are mounted within toner reservoir 212. Toner adder roll 220 moves toner supplied to toner reservoir 212 by toner cartridge 100 to developer roll 218. A doctor blade 222 is disposed along and engages with developer roll 218 to provide a substantially uniform layer of toner on developer roll 218 for subsequent transfer to the photoconductive drum in cleaner housing 204. Doctor blade 222 is mounted on a bracket 224 attached to housing 210. A rotating auger 226 and a gutter 228 are positioned laterally along an upper portion of toner reservoir 212 near inlet port 206. Gutter 228 includes a plurality of openings (not shown) spaced along its length. The openings extend through a bottom surface 229 of gutter 228. Toner entering inlet port 206 from toner cartridge 100 is distributed along the length of gutter 228 by the rotation of auger 226. The openings in gutter 228 allow the incoming toner to be distributed substantially evenly into toner reservoir 212. One or more paddles or agitators 230 may be positioned within reservoir 212 to stir and move the toner therein. Drive coupler 207 (shown in FIG. 2), through one or more intermediate gears positioned on the outside of side wall 215 and/or side wall 216, drives developer roll 218, toner adder roll 220, auger 226 and agitator(s) 230.

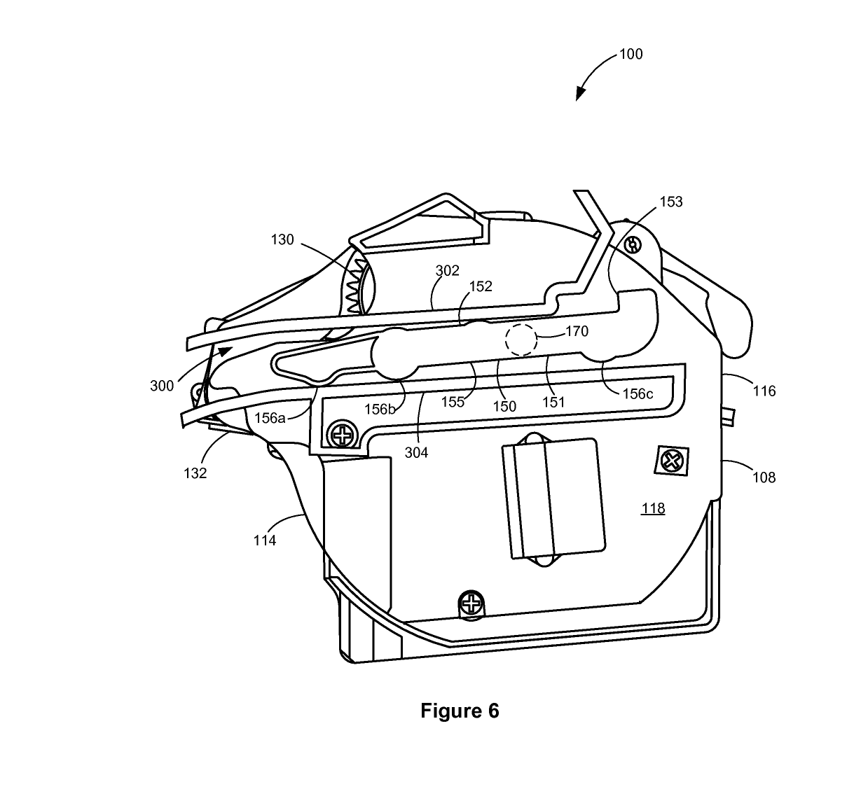

With reference to FIGS. 2 and 6, the side surface of each end cap 118, 120 of toner cartridge 100 includes an insertion alignment guide 150, 160 (for end cap 120 and insertion alignment guide 160 see FIG. 3). In the example embodiment illustrated, insertion alignment guides 150, 160 are integrally molded on end caps 118, 120. Alternatively, insertion alignment guides 150, 160 may be fixedly attached to end caps 118, 120 such as by suitable fasteners. Each insertion alignment guide 150, 160 includes a generally elongated body 151, 161 that extends from a rear portion of its end cap 118, 120 toward a front portion thereof. Insertion alignment guides 150, 160 are substantially parallel to each other. As toner cartridge 100 is inserted into image forming device 22, insertion alignment guides 150, 160 each travel along a respective insertion slot 300 defined by top and bottom guides 302, 304 running along an inner surface of image forming device 22. Insertion alignment guides 150, 160 support and locate toner cartridge 100 during insertion and in its final position within image forming device 22. In the example embodiment illustrated, a stop 153, 163 extends vertically upward from a top surface 152, 162 of each insertion alignment guide 150, 160. Stops 153, 163 limit the forward travel of toner cartridge 100 as it is inserted into image forming device 22. Specifically, as toner cartridge 100 advances into image forming device 22, stops 153, 163 contact top guide 302 to prevent toner cartridge 100 from advancing further thereby controlling the front-to-rear positioning of toner cartridge 100.

In one embodiment, a bottom surface 155, 165 of each respective insertion alignment guide 150, 160 includes one or more rounded projections 156, 166 that define contact points with bottom guide 304 of image forming device 22 to control the vertical positioning of toner cartridge 100. In the example embodiment illustrated, each insertion alignment guide 150, 160 includes three rounded projections 156a, 156b, 156c and 166a, 166b, 166c. In this embodiment, three of the four rounded projections 156b, 156c, 166b, 166c form datum points that define a plane that determines the vertical position of toner cartridge 100. As shown in dashed lines in FIG. 6 insertion alignment guide 150 includes a magnet 170 to actuate a magnetic sensor as discussed below.

With reference back to FIG. 2, each side of frame 205 of imaging unit 200 also includes an insertion alignment guide. A first insertion alignment guide 250 is shown on one side of frame 205 in FIG. 2. Insertion alignment guide 250 includes an elongated body 251 formed as a narrow extension along the side of frame 205. Body 251 includes a first substantially planar portion 252 that leads into a second substantially planar portion 253. In the example embodiment illustrated, a rounded nub 254 is positioned at the leading edge of body 251 to aid the initial insertion of imaging unit 200 into image forming device 22.

Insertion alignment guide 250 also includes an upper extension 255 toward a rear portion thereof. In this manner, the height of body 251 is less at its initial location of entry into image forming device 22 to facilitate insertion and greater at a location spaced rearward along body 251 toward developer unit 202. A second insertion alignment guide (not shown) is positioned on the opposite side of frame 205 but obscured by cleaner housing 204 in FIG. 2. The second insertion alignment guide is substantially a mirror image of first insertion alignment guide 250.

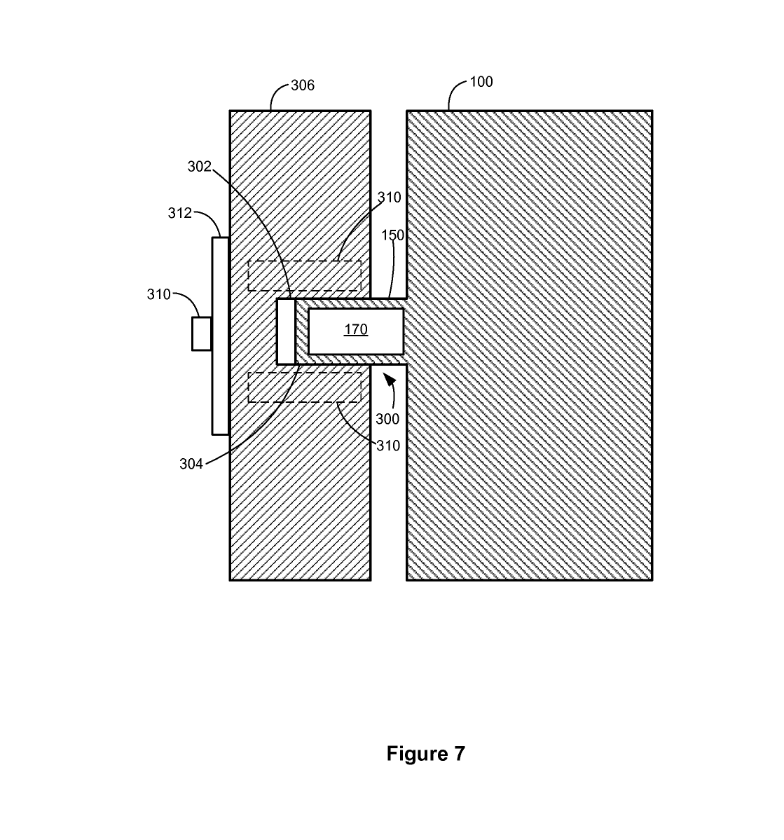

With reference to the schematic depiction shown in FIG. 7, a frame 306 of image forming device 22 includes a magnetic sensor 310 adjacent to insertion slot 300 that receives insertion alignment guide 150 or 160 of toner cartridge 100. Magnetic sensor 310 is configured to detect the presence or absence of a magnetic field near insertion slot 300. A corresponding magnet 170 is positioned on insertion alignment guide 150 or 160 of toner cartridge 100, such as on the exterior of insertion alignment guide 150 or 160 or within insertion alignment guide 150 or 160, corresponding to the insertion slot 300 having magnetic sensor 310 as discussed below. Accordingly, magnetic sensor 310 is configured to detect the presence or absence of toner cartridge 100 in image forming device 22. In one embodiment, magnetic sensor 310 is electrically connected to a laser power relay of laser scan unit 31 and configured to enable laser power when toner cartridge 100 is detected and to disable laser power when toner cartridge 100 is absent. In this manner, magnetic sensor 310 serves as a safety interlock to protect the user from the laser beam of LSU 31 when toner cartridge 100 is absent.

Magnetic sensor 310 may be any suitable device capable of detecting the presence or absence of a magnetic field and, as desired, capable of enabling and disabling the laser power relay based on the presence or absence of a magnetic field. For example, in the example embodiment illustrated, magnetic sensor 310 is a hall-effect sensor, which is a transducer that varies its electrical output in response to a magnetic field. In this embodiment, the hall-effect sensor is combined with circuitry on a printed circuit board 312 that allows the hall-effect sensor to act in a digital (on/off) mode (i.e., as a switch). In another embodiment, magnetic sensor 310 is a reed switch having contacts that remain open unless a magnetic field is present.

In the example embodiment illustrated, magnetic sensor 310 is mounted on the opposite side of frame 306 from insertion slot 300 so that magnetic sensor 310 is in close proximity to magnet 170 when toner cartridge 100 is installed in image forming device 22. Alternatively, magnetic sensor 310 may be mounted along top guide 302 or bottom guide 304 as shown in dashed lines in FIG. 7.

In one embodiment, frame 306 of image forming device 22 as well as housing 102 of toner cartridge 100, housing 210 of developer unit 202, the housing of cleaner unit 204 and frame 205 are formed from molded plastic and therefore do not interfere with the detectability of the magnetic field produced by magnet 170. However, if frame 306 of image forming device 22 is instead formed of a magnetic metal, magnetic sensor 310 may be mounted on a plastic insert positioned in a hole or recess in frame 306 to permit magnetic sensor 310 to accurately sense the presence or absence of toner cartridge 100 without interference from frame 306.

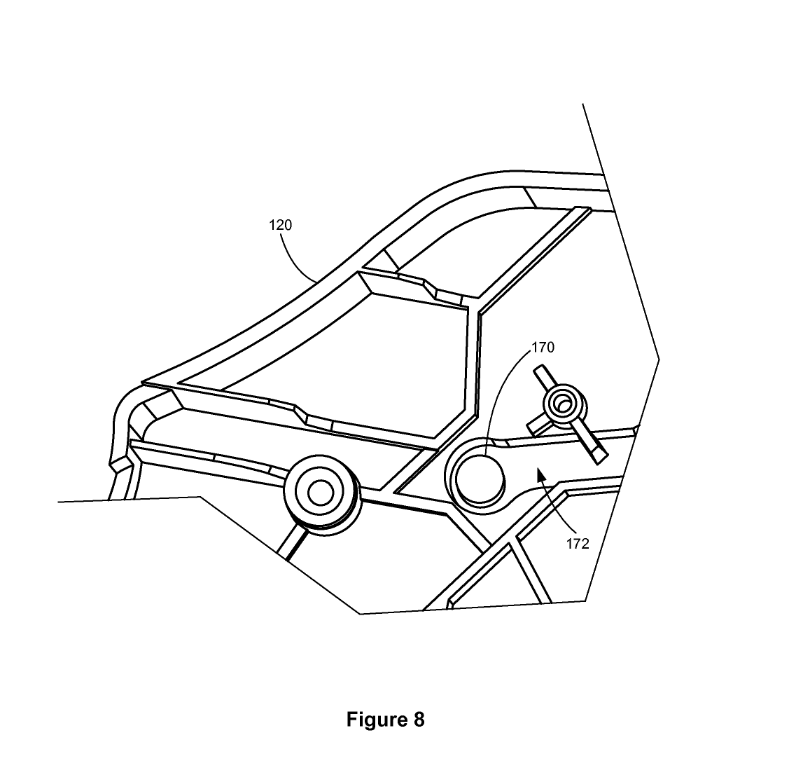

FIG. 8 shows a side view of the inner portion of end cap 118 when it is removed from toner cartridge 100. In the example embodiment illustrated, end cap 118 is formed from molded plastic and the inner portion of end cap 118 includes a hollow section 172 corresponding to the location of insertion alignment guide 150 on the outer portion of end cap 118. In this embodiment, magnet 170 is positioned in hollow section 172. Magnet 170 may be held in hollow section 172 using any suitable method such as, for example, by a friction fit, an adhesive, a fastener or a retaining member such as a bracket or mounting tabs. Magnet 170 is preferably positioned within insertion alignment guide 150 or 160 on the inner portion of end cap 118 or 120 so that magnet 170 is protected from mechanical damage. However, magnet 170 may also be positioned on the exterior of insertion alignment guide 150 or 160 or otherwise exposed to the exterior of insertion alignment guide 150 or 160 as desired. In the example embodiment illustrated, a circular magnet 170 is shown; however, magnet 170 may be any suitable shape such as, for example, square, rectangular, oval, thin, thick, amorphous, etc.

When toner cartridge 100 is inserted into image forming device 22, insertion alignment guide 150 or 160 having magnet 170 travels along insertion slot 300 in proximity to magnetic sensor 310 allowing magnetic sensor 310 to detect the presence of toner cartridge 100 and enable the laser beam of LSU 31. Similarly, when toner cartridge 100 is removed, magnetic sensor 310 detects the absence of magnet 170 and toner cartridge 100 and disables the laser beam of LSU 31. As a result, unlike the metal shorting strip discussed above, magnetic sensor 310 and magnet 170 provide a contactless means for enabling and disabling the laser beam of LSU 31 based on the presence or absence of toner cartridge 100. Further, positioning magnet 170 on insertion alignment guide 150 or 160 minimizes the distance required to sense the presence of magnet 170 thereby increasing the reliability of magnetic sensor 310. Positioning magnet 170 on insertion alignment guide 150 or 160 also permits the use of a relatively small magnet 170 and a magnetic sensor 310 having a minimal sensing ability thereby reducing the cost of manufacture and reducing the likelihood that magnetic sensor 310 will be inadvertently actuated by something other than magnet 170. Further, because insertion alignment guides 150, 160 serve as positional locating features for toner cartridge 100, magnet 170 is consistently positioned in its desired location relative to magnetic sensor 310 when toner cartridge 100 is inserted into image forming device 22.

Although magnet 170 is preferably positioned on insertion alignment guide 150 or 160, magnet 170 may also be positioned elsewhere on toner cartridge 100 as desired so long as the magnetic field from magnet 170 is sufficient to actuate magnetic sensor 310 when toner cartridge 100 is installed in image forming device 22. For example, in one embodiment, magnetic sensor 310 is capable of detecting a magnetic field of at least about 5 Gauss. Accordingly, in this embodiment, magnet 170 may produce a magnetic field of about 5 Gauss and be positioned on insertion alignment guide 150 or 160 in close proximity to magnetic sensor 310. Alternatively, magnet 170 may produce a magnetic field of greater than 5 Gauss and be positioned on a portion of toner cartridge 100 located farther from magnetic sensor 310 so long as the magnetic field produced by magnet 170 is at least about 5 Gauss at the outer surface of insertion alignment guide 150 or 160 near magnetic sensor 310.

Some electrophotographic image forming devices utilize what is commonly referred to as a dual component developer system having magnetic carrier beads that convey toner to the photoconductive drum, the carrier beads and the toner making up the “dual” components. The magnetic carrier beads may be coated with a polymeric film to provide the desired triboelectric properties to attract the toner to the carrier beads. The carrier beads having the toner attracted thereto may then be transported near the photoconductive drum through the use of magnetic fields. Electrostatic forces from the latent image on the photoconductive drum then strip the toner from the magnetic carrier beads to provide a toned image on the surface of the photoconductive drum. Where the image forming device includes a dual component developer system, the insertion alignment guide having the magnet for actuating the magnetic sensor may further include an iron backing positioned between the magnet and the contents of the toner cartridge in order to prevent the magnetic field of the insertion alignment guide magnet from disturbing magnetic carrier beads that may be stored in the toner cartridge.

It will also be understood that insertion alignment guides 150, 160 discussed above are merely meant to serve as examples and that other positioning guides or extensions may be used as desired. For example, toner cartridge 100 may include a pair of insertion alignment guides similar to insertion alignment guide 250 discussed above with respect to imaging unit 200. Other examples include a continuous rectangular or tapered extension such as a rib or a series of aligned (e.g., linearly aligned) extensions such as ribs, wings or pegs. Further, the guides may be positioned on the top, bottom, front, rear or sides of toner cartridge 100 as desired. The guides may also be formed on or attached to a main body portion of toner cartridge 100 or on a component attached thereto such as end cap 118 or 120. Toner cartridge 100 and imaging unit 200 may also be inserted into the image forming device at any suitable loading angle such as, for example, a generally downward direction, a generally forward direction, a generally sideways direction or an angled direction with respect to toner cartridge 100 and imaging unit 200.

While the example embodiment discussed above with respect to FIGS. 6-8 includes magnet 170 positioned on insertion alignment guide 150 or 160 of toner cartridge 100, it will be appreciated that a magnet may be positioned on any replaceable unit of the image forming device such as, for example, imaging unit 200. For example, a magnet may be positioned on one of the insertion alignment guides on frame 205 as desired. A magnet on imaging unit 200 may be used in place of magnet 170 on toner cartridge 100 such that the laser beam of LSU 31 will be enabled when imaging unit 200 is installed in image forming device 22 regardless of whether toner cartridge 100 is installed. Alternatively, a magnet may be used on imaging unit 200 in addition to magnet 170 on toner cartridge 100 so that the laser beam of LSU 31 will remain disabled unless both imaging unit 200 and toner cartridge 100 are installed in image forming device 22.

Further, although the example image forming device 22 discussed above includes a pair of replaceable units in the form of toner cartridge 100 and imaging unit 200, it will be appreciated that the replaceable unit(s) of the image forming device may employ any suitable configuration as desired. For example, in one embodiment, the main toner supply for the image forming device, the developer unit, and the cleaner unit including the photoconductive drum are housed in one replaceable unit. In another embodiment, the main toner supply for the image forming device and the developer unit are provided in a first replaceable unit and the cleaner unit including the photoconductive drum is provided in a second replaceable unit. Further, although the example image forming device 22 discussed above includes one toner cartridge and corresponding imaging unit, in the case of an image forming device configured to print in color, separate replaceable units may be used for each toner color needed. For example, in one embodiment, the image forming device includes four toner cartridges and four corresponding imaging units, each toner cartridge containing a particular toner color (e.g., black, cyan, yellow and magenta) and each imaging unit corresponding with one of the toner cartridges to permit color printing. In this embodiment, one, some or all of the toner cartridges and/or imaging units may include a magnet positioned to actuate a corresponding magnetic sensor in the image forming device.

The foregoing description illustrates various aspects of the present disclosure.

It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. A replaceable unit for an electrophotographic image forming device, comprising:
a housing having a reservoir for storing a quantity of toner; and
an insertion alignment guide on the housing, the insertion alignment guide having a magnet for detection by a magnetic sensor in the image forming device.

2. The replaceable unit of claim 1, wherein the magnet is positioned within the insertion alignment guide.

3. The replaceable unit of claim 1, wherein the magnet is positioned in a hollow section on an inner surface of the insertion alignment guide.

4. The replaceable unit of claim 1, wherein the magnet produces a magnetic field of at least about 5 Gauss.

5. The replaceable unit of claim 1, wherein the insertion alignment guide includes a pair of insertion alignment guides positioned on opposite sides of the housing, the magnet being positioned on at least one of the pair of insertion alignment guides.

6. A replaceable unit for an electrophotographic image forming device, comprising:
a housing having a reservoir for storing a quantity of toner;
a guide on the housing for aligning the replaceable unit when the replaceable unit is inserted in the image forming device; and
a magnet on the guide detectable by a magnetic sensor in the image forming device when the replaceable unit is inserted in the image forming device.

7. The replaceable unit of claim 6, wherein the magnet is positioned within the guide.

8. The replaceable unit of claim 6, wherein the magnet is positioned in a hollow section on an inner surface of the guide.

9. The replaceable unit of claim 6, wherein the magnet produces a magnetic field of at least about 5 Gauss.

10. The replaceable unit of claim 6, wherein the guide includes a pair of guides positioned on opposite sides of the housing, the magnet being positioned on at least one of the pair of guides.

11. A replaceable unit for use in an electrophotographic image forming device, comprising:
a housing having a reservoir for storing a quantity of toner;
an insertion alignment guide on the housing; and
a magnet on the housing producing a magnetic field of at least about 5 Gauss at an outer surface of the insertion alignment guide.

12. The replaceable unit of claim 11, wherein the magnet is positioned on the insertion alignment guide.

13. The replaceable unit of claim 12, wherein the magnet is positioned within the insertion alignment guide.

14. The replaceable unit of claim 12, wherein the magnet is positioned in a hollow section on an inner surface of the insertion alignment guide.

15. The replaceable unit of claim 11, wherein the insertion alignment guide includes a pair of insertion alignment guides positioned on opposite sides of the housing, the magnet being positioned to produce a magnetic field of at least about 5 Gauss at an outer surface of at least one of the pair of insertion alignment guides.
